(19) United States
(12) Patent Application Publication
(10) Pub. No.: US 2025/0163940 A1
(43) Pub. Date: May 22, 2025

(54) COMPRESSOR AND REFRIGERATION APPARATUS

(71) Applicant: DAIKIN INDUSTRIES, LTD., Osaka (JP)

(72) Inventors: Shogo TSUCHIKAWA, Osaka (JP); Yudai IWAI, Osaka (JP); Takuya ISHINO, Osaka (JP)

(21) Appl. No.: 19/025,102

(22) Filed: Jan. 16, 2025

Related U.S. Application Data
(63) Continuation of application No. PCT/JP2023/018629, filed on May 18, 2023.

(30) Foreign Application Priority Data
Jul. 29, 2022 (JP) 2022-122029

(51) Int. Cl. F15B 1/04; F25B 31/02

(52) U.S. Cl. CPC F15B 1/04; F25B 31/02

(57) ABSTRACT

A compressor includes a compressor body casing, a compression mechanism unit provided in the compressor body casing, and an accumulator provided outside the compressor body casing and connected to the compression mechanism unit via at least one outlet pipe. The accumulator has at least one through hole through which the outlet pipe is inserted. In a plan view as viewed along a center axis direction of the accumulator, a center or a center of gravity of at least one portion where the outlet pipe is inserted into the through hole is located closer to the compressor body casing than a center axis of the accumulator.

### CROSS-REFERENCE TO RELATED APPLICATIONS

This is a continuation of International Application No. PCT/JP2023/018629 filed on May 18, 2023, which claims priority under 35 U.S.C. § 119(a) to Patent Application No. 2022-122029, filed in Japan on Jul. 29, 2022, all of which are hereby expressly incorporated by reference into the present application.

### BACKGROUND

### Technical Field

The present disclosure relates to a compressor and a refrigeration apparatus.

### Background Art

A compressor having an accumulator with one outlet pipe is known (see, for example, WO 2020/235076A). In such a compressor, the outlet pipe is inserted into a bottom of the accumulator so as to coincide with a center axis of a body of the accumulator.

Further, as another known compressor, there is a compressor having an accumulator with a plurality of outlet pipes (see, for example, JP 64-44388 Y and WO 2019/142408 A). In such a compressor with the plurality of outlet pipes, the plurality of outlet pipes are inserted into a bottom of the accumulator so as to make a center of gravity of the insertion positions of the plurality of outlet pipes coincident with a center axis of the accumulator in a top view of the accumulator.

### SUMMARY

A compressor of a first aspect of the present disclosure includes:
a compressor body casing;
a compression mechanism unit provided in the compressor body casing; and
an accumulator provided outside the compressor body casing and connected to the compression mechanism unit via an outlet pipe, the accumulator having a through hole through which the outlet pipe is inserted,
in which, in a plan view as viewed from a center axis direction of the accumulator, a center or a centroid of a portion where the outlet pipe is inserted into the through hole is located closer to the compressor body casing than a center axis of the accumulator.

### BRIEF DESCRIPTION OF THE DRAWINGS

FIG. 1 is a schematic side view of a compressor of a first embodiment of the present disclosure.

FIG. 2 is a schematic plan view of the compressor of the first embodiment as viewed from above an accumulator.

FIG. 3 is a schematic side view of a compressor of a second embodiment of the present disclosure.

FIG. 4 is a schematic plan view of the compressor of the second embodiment as viewed from above an accumulator.

FIG. 5 is a schematic side view of a compressor of a third embodiment of the present disclosure.

FIG. 6 is a schematic plan view of the compressor of the third embodiment as viewed from above an accumulator.

FIG. 7 is a schematic plan view of a compressor of a first modification as viewed from above an accumulator.

FIG. 8 is a schematic plan view of a compressor of a second modification as viewed from above an accumulator.

FIG. 9 is a schematic side view of a compressor of a fourth embodiment of the present disclosure.

FIG. 10 is a schematic side view of a compressor of a fifth embodiment of the present disclosure.

FIG. 11 is a circuit diagram of an air conditioner as an example of a refrigeration apparatus including a refrigerant circuit using a compressor of a sixth embodiment of the present disclosure.

### DETAILED DESCRIPTION OF EMBODIMENT(S)

Hereinafter, embodiments will be described. Note that, in the drawings, the same reference numerals represent the same or corresponding parts. In addition, the dimensions on the drawings, such as lengths, widths, thicknesses, and depths, are appropriately changed from actual scales for clarity and simplification of the drawings, and do not represent actual relative dimensions.

### First Embodiment

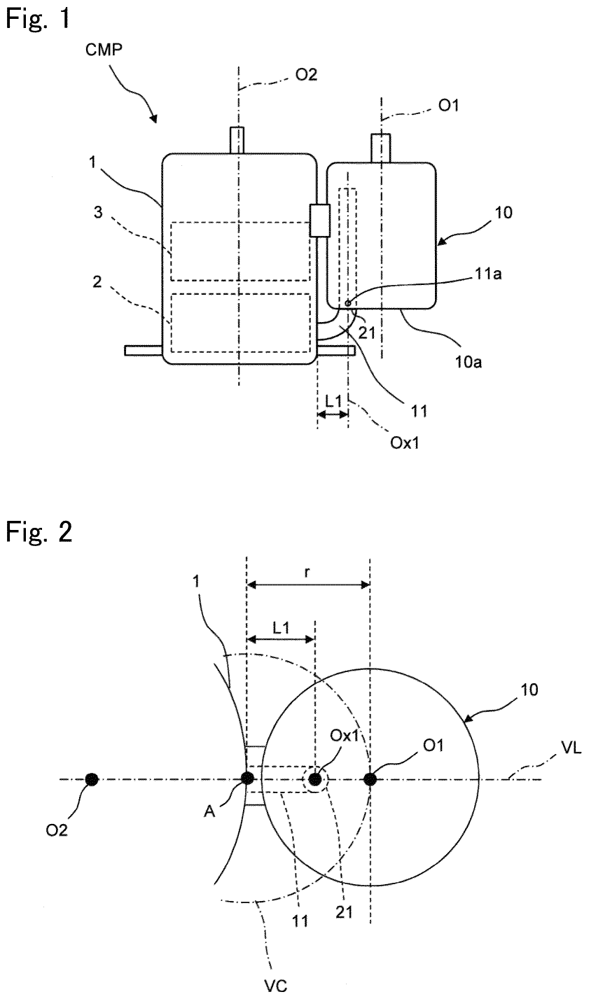

FIG. 1 is a schematic side view of a compressor CMP of a first embodiment of the present disclosure. The compressor CMP is a single-cylinder rotary compressor.

As shown in FIG. 1, the compressor CMP of the first embodiment includes a compressor body casing 1, a compression mechanism unit 2 disposed in the compressor body casing 1, and a motor 3 disposed above the compression mechanism unit 2 in the compressor body casing 1 and configured to drive the compression mechanism unit 2 via a shaft (not shown). The compressor body casing 1 has a cylindrical outer peripheral surface.

The compressor CMP includes an accumulator 10 provided outside the compressor body casing 1 and connected to the compression mechanism unit 2 via an outlet pipe 11. The accumulator 10 has a cylindrical outer peripheral surface. A lower end (end in a center axis direction) of the accumulator 10 has a flat portion 10a extending along a radial direction of the accumulator 10. The flat portion 10a is provided with a through hole 21 through which the outlet pipe 11 is inserted.

The outlet pipe 11 communicates with a space in the accumulator 10 and has an oil return hole 11a located near the lowermost portion of the accumulator 10. The oil return hole 11a is spaced about 5 mm to 15 mm apart from a bottom surface of the accumulator 10 in a height direction.

The compression mechanism unit 2 sucks in refrigerant gas from the accumulator 10 through the outlet pipe 11. Controlling a condenser, an expansion mechanism, and an evaporator (not shown) that constitute an air conditioner as an example of a refrigeration apparatus together with the compressor CMP generates the refrigerant gas.

FIG. 2 is a schematic plan view of the compressor CMP of the first embodiment as viewed from above the accumulator 10.

As shown in FIG. 2, in the plan view as viewed from above (the center axis direction of) of the accumulator 10, a center O×1 of a portion where the outlet pipe 11 is inserted into the through hole 21 is located closer to the compressor body casing 1 than a center axis O1 of the accumulator 10.

In the plan view, assuming a virtual straight line VL passing through a center axis O2 of the compressor body casing 1 and the center axis O1 of the accumulator 10 and a virtual circle VC centered on a point A at which the virtual straight line VL intersects with the outer peripheral surface of the compressor body casing 1 and having a radius r equal to a distance from the point A to the center axis O1 of the accumulator 10, the center O×1 of the portion where the outlet pipe 11 is inserted into the through hole 21 is located in the virtual circle VC.

In the compressor CMP having the above configuration, the center O×1 of the portion where the outlet pipe 11 is inserted into the through hole 21 is located to the compressor body casing 1 side relative to the center axis O1 of the accumulator 10 in the plan view as viewed from the center axis direction of the accumulator 10. This configuration makes a distance L1 from a connection position (point A) where the outlet pipe 11 is connected to the compressor body casing 1 to the center O×1 of the portion where the outlet pipe 11 is inserted into the through hole 21 of the accumulator 10 shorter than a corresponding distance of the known compressor in which the outlet pipe is inserted so as to coincide with the center axis of the accumulator, and the support rigidity of the accumulator 10 improves accordingly. It is therefore possible to suppress vibrations of the accumulator 10.

Since the center O×1 of the portion where the outlet pipe 11 is inserted into the through hole 21 of the accumulator 10 is located in the virtual circle VC, the distance L1 from the connection position (point A) where the outlet pipe 11 is connected to the compressor body casing 1 to the center O×1 of the portion where the outlet pipe 11 is inserted into the through hole 21 decreases to allow an improvement in the support rigidity of the accumulator 10.

In the first embodiment, the center O×1 of the portion where the outlet pipe 11 is inserted into the through hole 21 of the accumulator 10 is located in the virtual circle VC and on the virtual straight line VL in the plan view, so that the support rigidity of the accumulator 10 further improves.

Since the outlet pipe 11 is inserted through the through hole 21 provided in the flat portion 10a of the accumulator 10, the outlet pipe 11 can be easily connected to the accumulator 10.

Since the oil return hole 11a communicating with the space in the accumulator 10 is located near the lowermost portion of the accumulator 10, oil accumulated at a bottom of the accumulator 10 can be easily returned to the compressor body casing 1.

### Second Embodiment

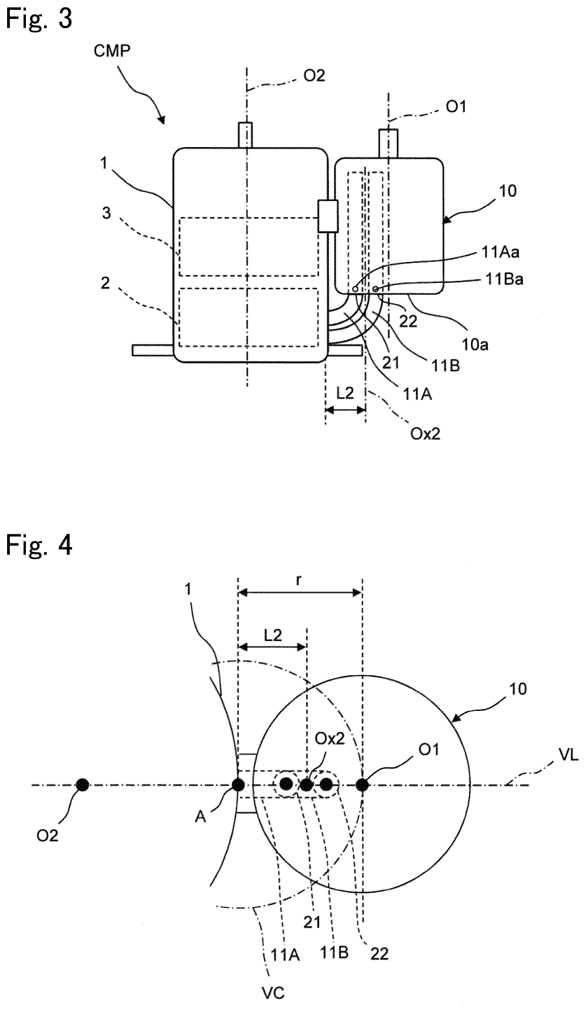

FIG. 3 is a schematic side view of a compressor CMP of a second embodiment of the present disclosure. The compressor CMP is a two-cylinder rotary compressor.

As shown in FIG. 3, the compressor CMP of the second embodiment includes a compressor body casing 1, a compression mechanism unit 2 disposed in the compressor body casing 1, and a motor 3 disposed above the compression mechanism unit 2 in the compressor body casing 1 and configured to drive the compression mechanism unit 2 via a shaft (not shown). The compressor body casing 1 has a cylindrical outer peripheral surface.

The compressor CMP includes an accumulator 10 provided outside the compressor body casing 1 and connected to the compression mechanism unit 2 via two outlet pipes 11A and 11B. The accumulator 10 has a cylindrical outer peripheral surface. A lower end (end in a center axis direction) of the accumulator 10 has a flat portion 10a extending along a radial direction of the accumulator 10. The flat portion 10a is provided with a through hole 21 through which the outlet pipe 11A is inserted. The flat portion 10a is further provided with a through hole 22 through which the outlet pipe 11B is inserted.

The outlet pipe 11A communicates with a space in the accumulator 10 and has an oil return hole 11Aa located near the lowermost portion of the accumulator 10. The outlet pipe 11B communicates with the space in the accumulator 10 and has an oil return hole 11Ba located near the lowermost portion of the accumulator 10.

The oil return holes 11Aa and 11Ba are each spaced about 5 mm to 15 mm apart from a bottom surface of the accumulator 10 in a height direction.

FIG. 4 is a schematic plan view of the compressor CMP of the second embodiment as viewed from above the accumulator 10.

As shown in FIG. 4, in the plan view as viewed from above (the center axis direction of) the accumulator 10, a center of gravity O×2 of a portion where the outlet pipe 11A is inserted into the through hole 21 and a portion where the outlet pipe 11B is inserted into the through hole 22 is located closer to the compressor body casing 1 than a center axis O1 of the accumulator 10. Here, the center of gravity O×2 corresponds to a center of gravity of the center position of each portion, and coordinates of the center of gravity O×2 are given by an arithmetic mean of center of gravity coordinates of the through holes 21 and 22.

In the plan view, assuming a virtual straight line VL passing through a center axis O2 of the compressor body casing 1 and the center axis O1 of the accumulator 10 and a virtual circle VC centered on a point A at which the virtual straight line VL intersects with the outer peripheral surface of the compressor body casing 1 and having a radius r equal to a distance from the point A to the center axis O1 of the accumulator 10, the center of gravity O×2 is located in the virtual circle VC.

In the compressor CMP having the above configuration, in the plan view as viewed from the center axis direction of the accumulator 10, the center of gravity O×2 of the portion where the outlet pipe 11A is inserted into the through hole 21 and the portion where the outlet pipe 11B is inserted into the through hole 22 is located closer to the compressor body casing 1 than the center axis O1 of the accumulator 10. This configuration makes a distance L2 from a connection position (point A) where the outlet pipe 11 is connected to the compressor body casing 1 to the center of gravity O×2 shorter than a corresponding distance of the known compressor in which the center of gravity of the two outlet pipes is located on the center axis of the accumulator, and the support rigidity of the accumulator 10 improves accordingly. It is therefore possible to suppress vibrations of the accumulator 10.

Since the center of gravity O×2 of the portion where the outlet pipe 11A is inserted into the through hole 21 and the portion where the outlet pipe 11B is inserted into the through hole 22 is located in the virtual circle VC, the distance L2 from the connection position (point A) where the outlet pipe 11 is connected to the compressor body casing 1 to the center of gravity O×2 decreases to allow an improvement in the support rigidity of the accumulator 10.

In the second embodiment, the center of gravity O×2 is located in the virtual circle VC and on the virtual straight line VL in the plan view, so that the support rigidity of the accumulator 10 further improves.

Since the outlet pipe 11A is inserted through the through hole 21 provided in the flat portion 10a of the accumulator 10 and the outlet pipe 11B is inserted through the through hole 22 provided in the flat portion 10a of the accumulator 10, the outlet pipes 11A and 11B can be easily connected to the accumulator 10.

Since the oil return hole 11Aa communicating with the space in the accumulator 10 is located near the lowermost portion of the accumulator 10, and the oil return hole 11Ba communicating with the space in the accumulator 10 is located near the lowermost portion of the accumulator 10, oil accumulated at a bottom of the accumulator 10 can be easily returned to the compressor body casing 1.

### Third Embodiment

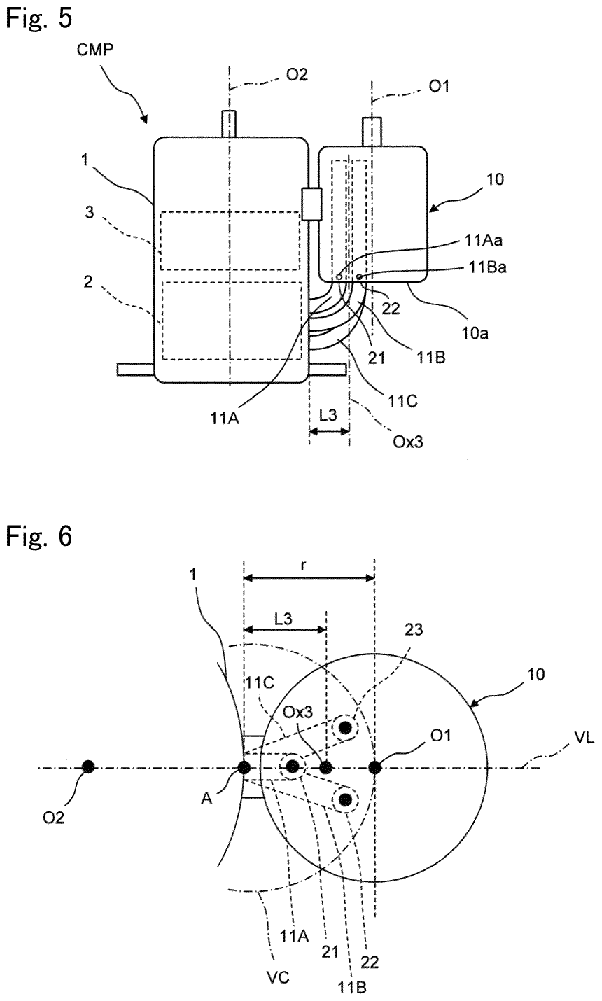

FIG. 5 is a schematic side view of a compressor CMP of a third embodiment of the present disclosure. The compressor CMP is a three-cylinder rotary compressor.

The compressor CMP includes an accumulator 10 provided outside a compressor body casing 1 and connected to a compression mechanism unit 2 via three outlet pipes 11A, 11B, and 11C. The accumulator 10 has a cylindrical outer peripheral surface. A lower end (end in a center axis direction) of the accumulator 10 has a flat portion 10a extending along a radial direction of the accumulator 10. The flat portion 10a is provided with a through hole 21 through which the outlet pipe 11A is inserted. The flat portion 10a is provided with a through hole 22 through which the outlet pipe 11B is inserted. The flat portion 10a is provided with a through hole 23 through which the outlet pipe 11C is inserted.

The outlet pipe 11A communicates with a space in the accumulator 10 and has an oil return hole 11Aa located near the lowermost portion of the accumulator 10. The outlet pipe 11B communicates with the space in the accumulator 10 and has an oil return hole 11Ba located near the lowermost portion of the accumulator 10. The outlet pipe 11C communicates with the space in the accumulator 10 and has an oil return hole (not shown) located near the lowermost portion of the accumulator 10.

The oil return holes 11Aa and 11Ba and the oil return hole of the outlet pipe 11C are each spaced about 5 mm to 15 mm apart from a bottom surface of the accumulator 10 in a height direction.

FIG. 6 is a schematic plan view of the compressor CMP of the third embodiment as viewed from above the accumulator 10.

As shown in FIG. 6, in the plan view as viewed from above (the center axis direction of) the accumulator 10, a center of gravity O×3 of a portion where the outlet pipe 11A is inserted into the through hole 21, a portion where the outlet pipe 11B is inserted into the through hole 22, and a portion where the outlet pipe 11C is inserted into the through hole 23 is located closer to the compressor body casing 1 than a center axis O1 of the accumulator 10. Here, the center of gravity O×3 corresponds to a center of gravity of the center position of each portion, and the center of gravity of O×3 is given by an arithmetic mean of center of gravity coordinates of the through holes 21, 22, and 23.

In the plan view, assuming a virtual straight line VL passing through a center axis O2 of the compressor body casing 1 and the center axis O1 of the accumulator 10 and a virtual circle VC centered on a point A at which the virtual straight line VL intersects with the outer peripheral surface of the compressor body casing 1 and having a radius r equal to a distance from the point A to the center axis O1 of the accumulator 10, the center of gravity O×3 is located in the virtual circle VC.

In the compressor CMP having the above configuration, in the plan view as viewed from the center axis direction of the accumulator 10, the center of gravity O×3 of the portion where the outlet pipe 11A is inserted into the through hole 21, the portion where the outlet pipe 11B is inserted into the through hole 22, and the portion where the outlet pipe 11C is inserted into the through hole 23 is located closer to the compressor body casing 1 than the center axis O1 of the accumulator 10. This configuration makes a distance L3 from a connection position (point A) where the outlet pipe 11 is connected to the compressor body casing 1 to the center of gravity O×3 shorter than a corresponding distance of the known compressor in which the center of gravity of the plurality of outlet pipes is located on the center axis of the accumulator, and the support rigidity of the accumulator 10 improves accordingly. It is therefore possible to suppress vibrations of the accumulator 10.

Since the center of gravity O×3 of the portion where the outlet pipe 11A is inserted into the through hole 21, the portion where the outlet pipe 11B is inserted into the through hole 22, and the portion where the outlet pipe 11C is inserted into the through hole 23 is located in the virtual circle VC, the distance L3 from the connection position (point A) where the outlet pipes 11A, 11B, and 11C is connected to the compressor body casing 1 to the center of gravity O×3 decreases to allow an improvement in the support rigidity of the accumulator 10.

In the third embodiment, the center of gravity O×3 is located in the virtual circle VC and on the virtual straight line VL in the plan view, so that the support rigidity of the accumulator 10 further improves.

Since the outlet pipes 11A, 11B, and 11C are inserted through the through holes 21, 22, and 23 provided in the flat portion 10a of the accumulator 10, the outlet pipes 11A, 11B, and 11C can be easily connected to the accumulator 10.

Since the oil return hole 11Aa communicating with the space in the accumulator 10 is located near the lowermost portion of the accumulator 10, the oil return hole 11Ba communicating with the space in the accumulator 10 is located near the lowermost portion of the accumulator 10, and the oil return hole of the outlet pipe 11C communicating with the space in the accumulator 10 is located near the lowermost portion of the accumulator 10, oil accumulated at a bottom of the accumulator 10 can be easily returned to the compressor body casing 1.

In the third embodiment, all of the portion where the outlet pipe 11A is inserted into the through hole 21, the portion where the outlet pipe 11B is inserted into the through hole 22, and the portion where the outlet pipe 11C is inserted into the through hole 23 are located in the virtual circle VC; however, the present disclosure is not limited to such a configuration, and it is only required that the center of gravity O×3 be located in the virtual circle VC.

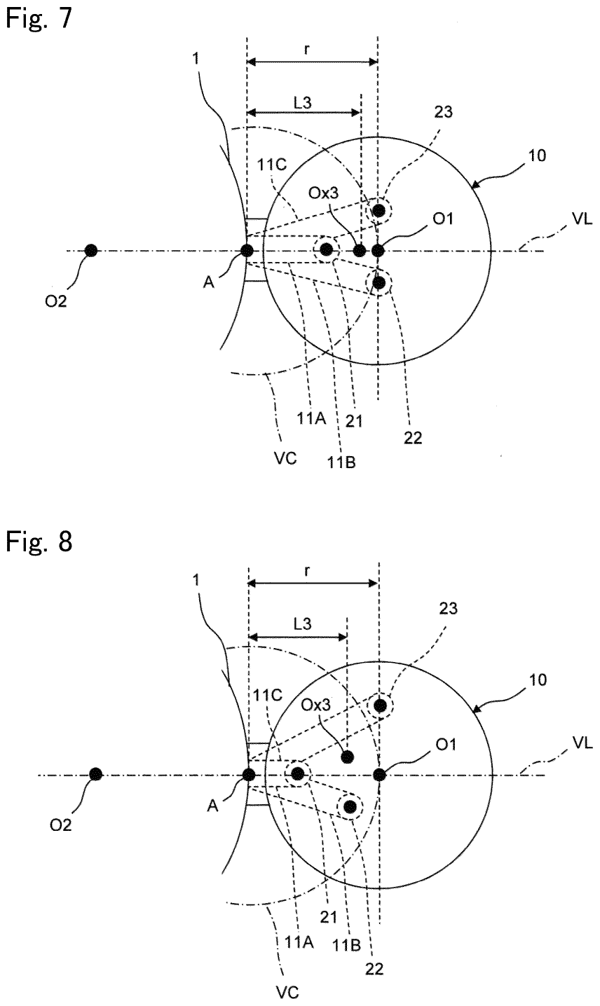

For example, as in a first modification shown in FIG. 7, even if the portion where the outlet pipe 11A is inserted into the through hole 21 is located in the virtual circle VC, and the portion where the outlet pipe 11B is inserted into the through hole 22 and the portion where the outlet pipe 11 C is inserted into the through hole 23 are located outside the virtual circle VC, it is only required that the center of gravity O×3 be located in the virtual circle VC.

As in a second modification shown in FIG. 8, even if the portion where the outlet pipe 11A is inserted into the through hole 21 and the portion where the outlet pipe 11B is inserted into the through hole 22 are located in the virtual circle VC, and the portion where the outlet pipe 11C is inserted into the through hole 23 is located outside the virtual circle VC, it is only required that the center of gravity O×3 be located in the virtual circle VC.

### Fourth Embodiment

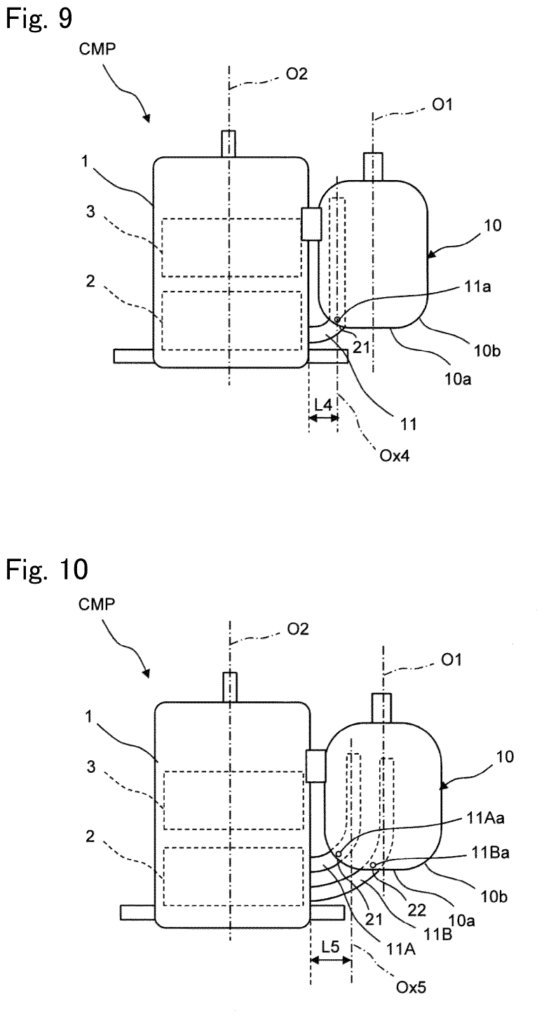

FIG. 9 is a schematic side view of a compressor CMP of a fourth embodiment of the present disclosure. The compressor CMP of the fourth embodiment has the same configuration as of the compressor CMP of the first embodiment except for the shape of the accumulator 10 and the position where the outlet pipe 11 is inserted.

As shown in FIG. 9, the compressor CMP of the fourth embodiment includes an accumulator 10 provided outside a compressor body casing 1 and connected to a compression mechanism unit 2 via an outlet pipe 11. The accumulator 10 has a cylindrical outer peripheral surface.

A lower end (end in a center axis direction) of the accumulator 10 has a flat portion 10a extending along a radial direction of the accumulator 10 and a curved portion 10b contiguous with an outer peripheral side surface and extending between a flat portion 10a and the outer peripheral side surface. The curved portion 10b is provided with a through hole 21 through which the outlet pipe 11 is inserted.

The compressor CMP having the above configuration, as compared with the case where the outlet pipe 11 is inserted into the flat portion 10a, can increase strength of a connection portion between the through hole 21 of the accumulator 10 and the outlet pipe 11 in the curved portion 10b, decrease a distance L4 from a connection position where the outlet pipe 11 is connected to the compressor body casing 1 to a center O×4 of the portion where the outlet pipe 11 is inserted into the through hole 21 of the accumulator 10, increase rigidity of the connection portion between the accumulator 10 and the outlet pipe 11, and further improve the support rigidity of the accumulator 10.

The compressor CMP of the fourth embodiment has effects similar to those of the compressor CMP of the first embodiment.

### Fifth Embodiment

FIG. 10 is a schematic side view of a compressor CMP of a fifth embodiment of the present disclosure. The compressor CMP is a two-cylinder rotary compressor.

As shown in FIG. 10, the compressor CMP includes an accumulator 10 provided outside a compressor body casing 1 and connected to a compression mechanism unit 2 via outlet pipes 11A and 11B. The accumulator 10 has a cylindrical outer peripheral surface. A lower end (end in a center axis direction) of the accumulator 10 has a flat portion 10a extending along a radial direction of the accumulator 10 and a curved portion 10b contiguous with an outer peripheral side surface and extending between a flat portion 10a and the outer peripheral side surface. The curved portion 10b is provided with a through hole 21 through which the outlet pipe 11A is inserted. The flat portion 10a is provided with a through hole 22 through which the outlet pipe 11B is inserted.

The outlet pipe 11A communicates with a space in the accumulator 10 and has an oil return hole 11Aa located near the lowermost portion of the accumulator 10. The outlet pipe 11B communicates with the space in the accumulator 10 and has an oil return hole 11Ba located near the lowermost portion of the accumulator 10.

The oil return holes 11Aa and 11Ba are each spaced about 5 mm to 15 mm apart from a bottom surface of the accumulator 10 in a height direction.

In the fifth embodiment, as in the second embodiment, in the plan view as viewed from above (the center axis direction of) the accumulator 10, a center of gravity O×5 of a portion where the outlet pipe 11A is inserted into the through hole 21 and a portion where the outlet pipe 11B is inserted into the through hole 22 is located closer to the compressor body casing 1 than a center axis O1 of the accumulator 10. In the plan view, assuming a virtual straight line VL passing through a center axis O2 of the compressor body casing 1 and the center axis O1 of the accumulator 10 and a virtual circle VC centered on a point A at which the virtual straight line VL intersects with the outer peripheral surface of the compressor body casing 1 and having a radius r equal to a distance from the point A to the center axis O1 of the accumulator 10, the center of gravity O×5 is located in the virtual circle VC.

In the compressor CMP having the above configuration, a distance L5 from a connection position (point A) where the outlet pipe 11 is connected to the compressor body casing to the center of gravity O×5 becomes shorter than a corresponding distance of the known compressor in which the center of gravity of the two outlet pipes is located on the center axis of the accumulator, and the support rigidity of the accumulator 10 improves accordingly. It is therefore possible to suppress vibrations of the accumulator 10.

The compressor CMP of the fifth embodiment has effects similar to those of the compressor CMP of the second embodiment.

### Sixth Embodiment

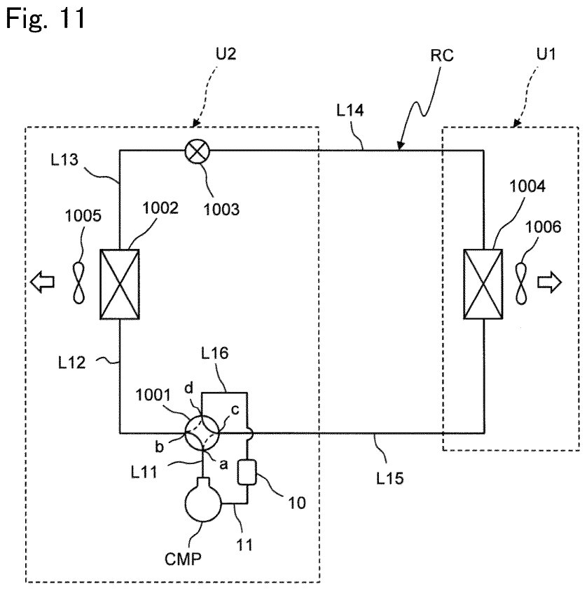

FIG. 11 is a circuit diagram of an air conditioner as an example of a refrigeration apparatus including a refrigerant circuit using a compressor CMP of a sixth embodiment of the present disclosure. Any one of the compressors CMP of the first to fifth embodiments is used for the refrigerant circuit RC.

As shown in FIG. 11, the air conditioner of the sixth embodiment includes an indoor unit U1 installed in an indoor space to be air-conditioned and an outdoor unit U2 installed outdoors.

### Configuration of Indoor Unit U1

The indoor unit U1 of the air conditioner includes an indoor heat exchanger 1004 having one end connected to a refrigerant pipe L14 (connection pipe) and the other end connected to a refrigerant pipe L15 (connection pipe), and an indoor fan 1006 that supplies air to the indoor heat exchanger 1004. The indoor fan 1006 blows out, toward the indoor space, air having temperature and the like adjusted by the indoor heat exchanger 1004.

### Configuration of Outdoor Unit U2

The outdoor unit U2 of the air conditioner includes the compressor CMP, a four-way switching valve 1001, an outdoor heat exchanger 1002, an expansion valve 1003 as an example of an expansion mechanism, the accumulator 10, an outdoor fan 1005 that sends air to the outdoor heat exchanger 1002.

The compressor CMP has a discharge side connected to a first port a of the four-way switching valve 1001 via a refrigerant pipe L11. The four-way switching valve 1001 has a second port b connected to one end of the outdoor heat exchanger 1002 via a refrigerant pipe L12. The outdoor heat exchanger 1002 has the other end connected to one end of the expansion valve 1003 via a refrigerant pipe L13, and the expansion valve 1003 has the other end connected to one end of the refrigerant pipe L14 (connection pipe). The refrigerant pipe L15 (connection pipe) has one end connected to a third port c of the four-way switching valve 1001. The four-way switching valve 1001 has a fourth port d connected to a suction side of the compressor CMP via a refrigerant pipe L16, the accumulator 10, and the outlet pipe 11.

The refrigerant flowing through the outdoor heat exchanger 1002 exchanges heat with air sucked by the outdoor fan 1005.

The expansion valve 1003 is, for example, an electric valve whose opening degree is adjustable, and the opening degree changes according to a signal from a control device (not shown).

Note that, in FIG. 11, the compression mechanism unit 2 and the accumulator 10 are connected via one outlet pipe 11, but in a case where the compressor CMP of one of the second to fifth embodiments is used, the compression mechanism unit 2 and the accumulator 10 are connected via two outlet pipes 11A and 11B or connected via three outlet pipes 11A, 11B, and 11C.

### Configuration of Refrigerant Circuit RC

Furthermore, the refrigerant circuit RC of the air conditioner includes the indoor heat exchanger 1004, the compressor CMP, the four-way switching valve 1001, the outdoor heat exchanger 1002, the expansion valve 1003, the accumulator 10, the refrigerant pipes L11 to L16, and the outlet pipe 11. Accordingly, an annular refrigerant circuit RC is configured.

As shown in FIG. 11, the four-way switching valve 1001 is switched to a switching position indicated by the solid line for cooling operation and is switched to a switching position indicated by the dotted line for heating operation to drive the compressor CMP, so as to cause the refrigerant to circulate through the refrigerant circuit RC.

According to the air conditioner having the above configuration, it is possible to achieve, by providing the refrigerant circuit RC using the compressor CMP, an air conditioner with vibrations of the compressor CMP suppressed.

In the sixth embodiment, the air conditioner has been described as the refrigeration apparatus, but the refrigeration apparatus including the refrigerant circuit RC using the compressor CMP is not limited to the air conditioner, and may be a refrigeration apparatus having another configuration.

In the first to fifth embodiments, the rotary compressor has been described; alternatively, the present disclosure may be applied to a compressor having another configuration such as a swing compressor.

In the first and fourth embodiments, a single-cylinder compressor with one outlet pipe has been described, in the second and fifth embodiments, a two-cylinder compressor with two outlet pipes has been described, and in the third embodiment, a three-cylinder compressor with three outlet pipes has been described; alternatively, the number of cylinders and the number of outlet pipes may be different. For example, the present disclosure may be applied to a two-cylinder compressor with one outlet pipe. For example, the number of outlet pipes may be four or more. The cross section of the outlet pipe and the shape of the through hole are not limited to a perfect circle, and may be, for example, an ellipse.

The foregoing description concerns specific embodiments of the present disclosure; however, the present disclosure is not limited to the first to sixth embodiments, and various modifications and variations may be made within the scope of the present disclosure.

1. A compressor comprising:
a compressor body casing;
a compression mechanism unit provided in the compressor body casing; and
an accumulator
provided outside the compressor body casing, and
connected to the compression mechanism unit via at least one outlet pipe,
the accumulator having at least one through hole through which the outlet pipe is inserted,
in a plan view as viewed along a center axis direction of the accumulator, a center or a center of gravity of at least one portion where the outlet pipe is inserted into the through hole being located closer to the compressor body casing than a center axis of the accumulator.

2. The compressor according to claim 1, wherein
in the plan view, a virtual straight line and a virtual circle are formed,
the virtual straight line passes through a center axis of the compressor body casing and the center axis of the accumulator,
the virtual circle
is centered on a point at which the virtual straight line intersects with an outer peripheral surface of the compressor body casing, and
has a radius equal to a distance from the point to the center axis of the accumulator, and
the center or the center of gravity is located in the virtual circle.

3. The compressor according to claim 2, wherein
the center or the center of gravity is located on the virtual straight line in the plan view.

4. The compressor according to claim 1, wherein
an end of the accumulator in the center axis direction has a flat portion extending along a radial direction of the accumulator, and
the through hole is provided in the flat portion.

5. The compressor according to claim 1, wherein
an end of the accumulator in the center axis direction has a curved portion contiguous with an outer peripheral side surface of the accumulator, and
the through hole is provided in the curved portion.

6. The compressor according to claim 1, wherein
the outlet pipe has an oil return hole
communicating with a space in the accumulator and
located near a lowermost portion of the accumulator.

7. A refrigeration apparatus including a compressor according to claim 1.
